(19) United States
(12) Patent Application Publication
(10) Pub. No.: US 2026/0298304 A1
(43) Pub. Date: Oct. 1, 2026

(54) DEVICE FOR SETTING THE PRESTRESSING FORCE OF A SPRING

(71) Applicant: Walter Stauffenberg GmbH & Co. KG, Werdohl (DE)

(72) Inventors: Ulrich Stefan KÖNIG, Herscheid (DE); Matthäus SCHULZ, Attendorn (DE)

(73) Assignee: Walter Stauffenberg GmbH & Co. KG, Werdohl (DE)

(21) Appl. No.: 19/478,870

(22) PCT Filed: Jul. 23, 2024
(86) PCT No.: PCT/EP2024/070924

§ 371 Date: Oct. 27, 2025

(30) Foreign Application Priority Data
Aug. 1, 2023 (EP) 23189021.1

(51) Int. Cl. F16F 1/12

(52) U.S. Cl. CPC F16F 1/121

(57) ABSTRACT

A device for setting the prestressing force of a spring includes two receiving bodies, which can be mutually displaceably guided through the respective other receiving body and between which the spring is held, wherein the receiving bodies and the spring have an opening aligned to one another for guiding through a threaded spindle and wherein an indicator for indicating the distance between the two receiving bodies is arranged. Further, a clip has such a device.

The invention relates to a device for setting the preloading force of a spring according to patent claim 1.

In order to fasten lines, in particular power cables, pipes and hoses, so-called clamps are regularly used that comprise a clamp body made of a thermoplastic or elastomeric plastic, or of metal. The clamp body is frequently formed from two fastening parts that can be braced against one another and that form a feedthrough for receiving the line when assembled.

EP 3 835 638 B1 describes a device for fastening lines, which device has two or three fastening parts which are braceable against one another. The fastening parts are swivelably interconnected via a hinge in each case. The first and the last fastening parts are detachably interconnected via a clamping device. A toggle-type fastener is arranged on the one end of an outer fastening part, the tensioning hook of which is bringable into engagement with a mating hook arranged on the other outer fastening part. The tensioning hook is designed in the form of an eyelet at the end and is connected to the clamping bracket of the toggle-type fastener via a threaded spindle.

A shaft is rotatably mounted between the limbs of a U-shaped clamping bracket. A threaded bore is introduced radially into the shaft, into which threaded bore the threaded spindle of the tensioning hook is screwed. A coil spring is slid onto the tensioning hook, which coil spring is preloaded between tensioning hook and shaft. The threaded spindle of the tensioning hook is secured at the end via a locknut. A further spring element is arranged on the threaded spindle between locknut and clamping bracket. Due to this further spring, the necessary clamping force of the toggle-type fastener is ensured even when the elasticity of the clamping blocks made of an elastomeric material decreases.

The above-described fastening device has proven useful in practice. The toggle-type fastener makes it possible to easily and quickly receive and fasten lines. Due to the second spring element, sufficient preloading is achieved to counteract a loosening of the fastening device when the elasticity of the clamping blocks made of an elastomeric material decreases. Sufficient preloading of the further spring is a prerequisite for a clamping connection that is reliable for the long term.

This is where the present invention comes into play. The problem addressed by the invention is that of providing a device for setting a preloading force of a spring, with which sufficient preloading is ensured. According to the invention, this problem is solved by a device having the features of patent claim 1.

The invention provides a device for setting a preloading force of a spring, with which sufficient preloading is ensured. Setting a defined preload is made possible due to the fact that two receiving bodies are arranged, which are mutually displaceably guided through the respective other receiving body and between which the spring is held, wherein the receiving bodies and the spring have an aligned opening for a threaded spindle to be passed through, and wherein means for indicating the distance between the two receiving bodies are arranged.

In a development of the invention, the means for indicating the distance comprise markings, which are arranged on the two receiving bodies such that they a movement of the markings on one receiving body along the markings on the other receiving body takes place according to the relative axial movement of the two receiving bodies relative to one another. As a result, a simple optical detection of the necessary preloading force having been reached is achieved, in that the markings on the two receiving bodies are aligned with one another.

In an embodiment of the invention, the receiving bodies are cup-shaped and telescopically engaged, wherein a marking is arranged on the outer lateral surface of the inner receiving body, which marking comprises axially spaced-apart lines, wherein the outer edge of the outer receiving body forms its marking. As a result, it is easier to achieve a robust design of the device.

In an alternative embodiment of the invention, at least one receiving body has at least one rib extending in the axial direction, which engages either into a cutout of the other receiving body, in which it is axially displaceable, or is displaceable along the other receiving body on the outside. Preferably, the receiving bodies each have an abutment plate provided with an opening, ribs being arranged on the abutment plate orthogonally thereto, which ribs are peripherally spaced apart from each other and delimit cutouts, wherein the ribs of the two receiving bodies each engage into the cutouts of the other receiving body, as a result of which a meshing connection is formed. The spring is held between the abutment plates of the two receiving bodies and can be preloaded by means of a relative motion of the two receiving bodies towards one another.

In a further embodiment of the invention, the receiving bodies each have three ribs, which are positioned on the respective abutment plate so as to be offset from one another by 120°. A stable arrangement is achieved as a result. Preferably, the abutment plate is designed in the shape of a hexagon, wherein one rib is arranged on each second side.

In a development of the invention, the markings are formed by at least two scales, which are axially spaced apart from one another and comprise peripheral lines. As a result, a position of the two receiving bodies relative to one another and, thus, a defined preloading, is settable.

In an embodiment of the invention, the receiving bodies are identically designed. Cost-effective manufacturing is supported as a result. Advantageously, the receiving bodies are produced as molded sheet metal parts.

In a further embodiment of the invention, the spring element is formed by a coil compression spring, wherein a collar framing the openings in the receiving bodies is directed in the direction of the other receiving body, which collar is encompassed by the spiral compression spring. As a result, a reliable seat of the spiral compression spring in the device is achieved.

The invention also relates to a clamp comprising at least two clamp parts, which are braceable against one another via a toggle-type fastener, wherein the toggle-type fastener has a threaded spindle which is preloaded via a spring, on which threaded spindle a device of the aforementioned type is arranged and which comprises the spring.

Other developments and embodiments of the invention are described in the remaining dependent claims. Exemplary embodiments of the invention are shown in the drawings and described in detail in the following. Wherein:

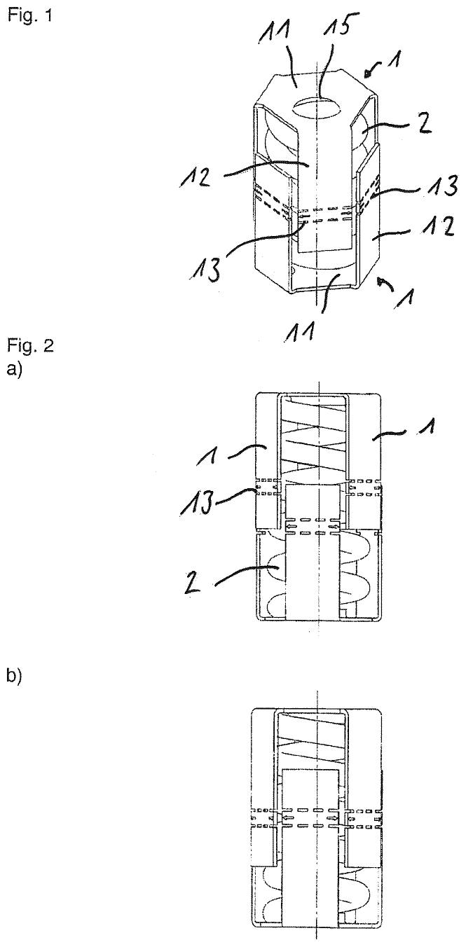

FIG. 1 shows the schematic view of a device for setting the preloading force of a spring;

FIG. 2 shows the view of the device from FIG. 1 in a side view
a) with insufficient spring preload (markings on the lower receiving body are arranged underneath the markings on the upper receiving body);
b) with sufficient spring preload (markings on the lower receiving body align with the markings on the upper receiving body);

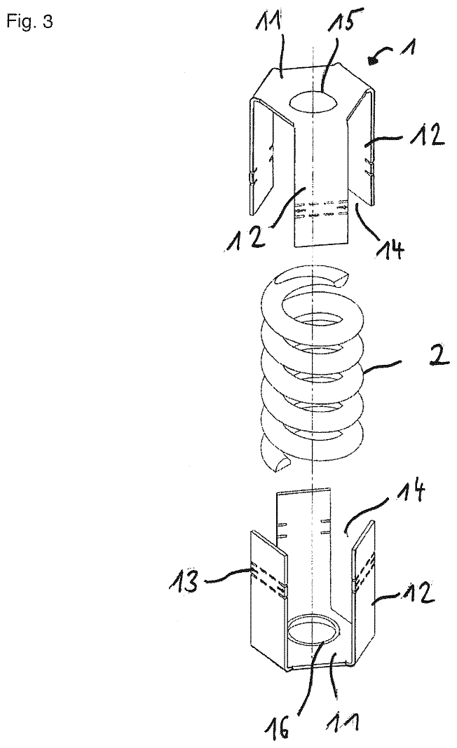

FIG. 3 shows the device from FIG. 1 in an exploded view;

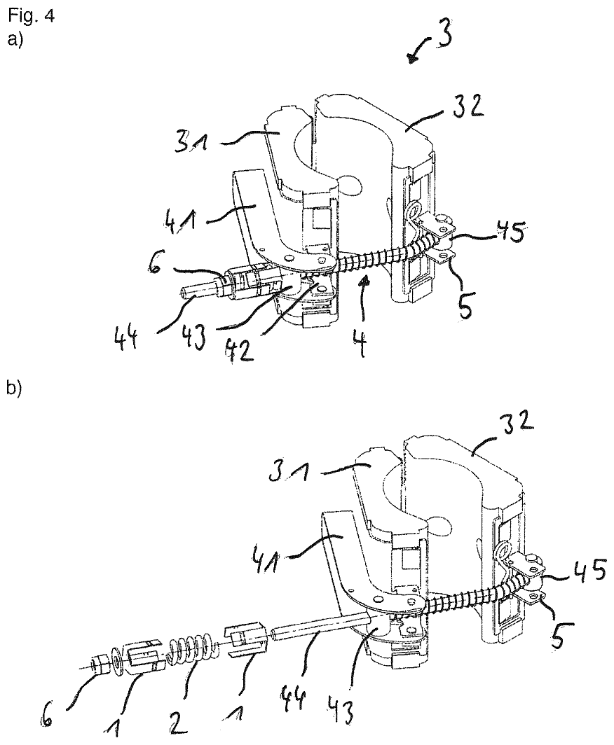

FIG. 4 shows the schematic view of a clamp for receiving lines
a) in the assembled state;
b) in a partially exploded view.

The device for setting the preloading force of a spring, which device has been selected as an exemplary embodiment, comprises two identically designed receiving bodies 1, between which a spiral compression spring 2 is arranged.

The receiving bodies 1 are each produced as a stamped and bent sheet-metal part and comprise an abutment plate 11, on which three ribs 12 are arranged orthogonally thereto, are peripherally offset from one another by 120 degrees, and delimit cutouts 14. In the exemplary embodiment, the abutment plate 1 is designed in the shape of a hexagon, wherein one of the three ribs 12 is arranged on each second side. A conical depression is introduced centrally into the abutment plate, which depression delimits a circular opening 15 and by means of which a peripheral collar 16 is formed on the underside of the abutment plate 1 facing the ribs 12. The ribs 12 are each provided with a scale 13 at the same level on the outside, which scales are formed by dashed lines.

The receiving bodies 1 are plugged together such that the ribs 12 of one receiving body 1 each engage into a cutout 14 in the oppositely located receiving body 1, as a result of which they are meshingly interconnected so as to displaceable relative to one another. The spiral compression spring 2 bears with one end against the collar 16 of a receiving body 1 in each case so as to border its abutment plate 11 at least in sections.

FIG. 1 shows a device which has been assembled in this way, wherein the two receiving bodies 1 are positioned axially relative to one another such that the scales 13 on the ribs 12 of the two receiving bodies 1 align with one another. In FIG. 2, a sufficient preloading force of the spiral compression spring 2 has not been achieved: The scales 13 on the ribs 12 of the lower receiving body 1 are located underneath the scales 13 on the ribs 12 of the upper receiving body 1.

FIG. 4 shows a clamp 3 with a toggle-type fastener 4, which is provided with a preloading device of the above-described type. The clamp 3 comprises a first clamp part 31 and a second clamp part 32, which are hingedly interconnected via a hinge, wherein a toggle-type fastener 4 is arranged, via which the two clamp parts 31, 32 are braceable against one another.

The toggle-type fastener 4 comprises a clamping bracket 41, which is swivelably mounted on an arm 42, which is fastened to a clamp part 31. The clamping bracket 41 is formed from a metal sheet bent in a U-shape, between the limbs of which a shaft 43 is rotatably mounted. A bore is introduced radially into the shaft 43, through which bore a threaded spindle 44 is guided, which threaded spindle has a hammer head 45 at the end, with which the one receptacle 5 arranged on the second clamp part 32 engages behind. The threaded spindle 44 is guided through the openings 15 in the two receiving bodies 1 of the preloading device and through the spiral compression spring 2 arranged between these, after which a preloading screw 6 is screwed onto the threaded spindle 44. Via the preloading screw 6, the preloading device is pressed against the shaft 43, wherein tightening the preloading screw 6 causes the receiving body 1 bearing against this to be moved against the oppositely located receiving body 1, as a result of which the spiral compression spring 2 is increasingly tensioned. A sufficient preload is achieved when the scales 13—which are highly visible from the outside—on the ribs 12 of the two receiving bodies 1 are in alignment with one another.

1. A device for setting the preloading force of a spring, comprising two receiving bodies (1), which are mutually displaceably guided through the respective other receiving body (1) and between which the spring (2) is held, wherein the receiving bodies (1) and the spring (2) have an aligned opening (15) for passing a threaded spindle (44) through, and wherein means for indicating the distance between the two receiving bodies (1) are arranged.

2. The device of claim 1, characterized wherein the means for indicating the distance comprise markings, which are arranged on the two receiving bodies (1) such that they a movement of the markings on one receiving body (1) along the markings on the other receiving body (1) takes place according to the relative axial movement of the two receiving bodies (1) relative to one another.

3. The device of claim 2, characterized in that wherein the receiving bodies are cup-shaped and telescopically engaged, wherein a marking is arranged on the outer lateral surface of the inner receiving body, wherein the marking comprises axially spaced-apart lines, wherein the outer edge of the outer receiving body forms its marking.

4. The device of claim 1, wherein at least one receiving body (1) has at least one rib extending in the axial direction, which engages either into a cutout of the other receiving body (1), in which it is axially displaceable, or is displaceable along the other receiving body (1) on the outside.

5. The device of claim 4, wherein the receiving bodies (1) each have an abutment plate (11) provided with an opening (15), ribs (12) being arranged on the abutment plate orthogonally thereto, which ribs are peripherally spaced apart from each other and delimit cutouts (14), wherein the ribs (12) of the two receiving bodies (1) each engage into the cutouts (14) of the other receiving body (1).

6. The device of claim 5, wherein the receiving bodies (1) each have three ribs (12), which are positioned on the respective abutment plate (11) so as to be offset from one another by 120°.

7. The device of claim 5, wherein at least two adjacent ribs (12) of the two receiving bodies (1) are each provided with a marking.

8. The device of claim 2, wherein the markings are formed by at least two scales (13), which are axially spaced apart from one another and comprise peripheral lines.

9. The device of claim 4, wherein the receiving bodies (1) are identically designed.

10. The device of claim 1, wherein the receiving bodies (1) are produced as molded sheet metal parts.

11. The device of claim 1, wherein the spring element is formed by a coil compression spring (2), wherein a collar (16) framing the openings (15) in the receiving bodies (1) is directed in the direction of the other receiving body (1), which collar is encompassed by the spiral compression spring (2).

12. A clamp (3) comprising at least two clamp parts (31, 32), which are braceable against one another via a toggle-type fastener (4), wherein the toggle-type fastener (4) has a threaded spindle which is preloaded via a spring (2), wherein the device of claim 1 is arranged on the threaded spindle (44), which device comprises the spring (2).
